(19) United States
(12) Patent Application Publication
(10) Pub. No.: US 2021/0383622 A1
(43) Pub. Date: Dec. 9, 2021

(54) METHOD FOR DIAGNOSING A SAFETY COMPONENT IN A MOTOR VEHICLE

(71) Applicant: Robert Bosch GmbH, Stuttgart (DE)

(72) Inventor: Levin Jungermann, Stuttgart (DE)

(21) Appl. No.: 17/285,331

(22) PCT Filed: Dec. 17, 2019
(86) PCT No.: PCT/EP2019/085616

§ 371 Date: Apr. 14, 2021

(30) Foreign Application Priority Data
Dec. 20, 2018 (DE) 10 2018 222 659.8

(51) Int. Cl. G07C 5/08; B60R 21/01

(52) U.S. Cl. CPC G07C 5/0808; B60T 7/12; B60R 21/01

(57) ABSTRACT

A method for operating a safety component in a motor vehicle. The method includes: determining a stored threshold value, which is provided for a comparison with an operating parameter of the safety component to set an error value when the operating parameter reaches the threshold value; ascertaining an error value when the threshold value is reached; collecting threshold-value correction data when the threshold value is reached or when a situation occurs in which it is expected that the threshold value will be reached, and transmitting threshold-value correction data to a central data processor; receiving from a central data processor at least one corrected threshold value for correcting the threshold value during the operation of the safety component, the correction data having been ascertained from error data that were ascertained in identically designed safety components of other motor vehicles; and adopting the corrected threshold as the stored threshold value.

### FIELD

The present invention relates to a method for diagnosing a safety component, especially for diagnosing a safety component in a motor vehicle.

### BACKGROUND INFORMATION

Generally, safety components in motor vehicles could be all types of active and passive safety components such as airbags, emergency braking systems, etc.

Safety components in a motor vehicle are frequently activated or deactivated as a function of input variables, the activation or deactivation frequently being accomplished by comparing one or more input variable(s) to one or more threshold value(s). If the input variable reaches the threshold value, then a condition that may be considered an error value is satisfied. It is often the case that safety components such as airbags or emergency braking systems are triggered not only by a single exceeded threshold value; instead, a plurality of necessary and sufficient conditions must be satisfied for the triggering of such a safety component. Necessary and sufficient conditions may be implemented in the form of comparisons of operating parameters with threshold values. Such conditions are normally stored in control units of the individual safety components or in central vehicle control units (ECUs).

In many ECUs (e.g., in an airbag), test limits (threshold values) for installed self-tests (built-in self-tests (BIST) as well as limits for filtering in and filtering out errors are currently specified during the development phase and programmed in the ECUs as values that remain constant across the service life of the ECU.

Such threshold value conditions are to be improved by the present invention disclosed herein.

### SUMMARY

In accordance with an example embodiment of the present invention, a method for operating a safety component in a motor vehicle is provided, the method having the following steps:
a) Determining a stored threshold value, which is provided to be compared with an operating parameter of the safety component in order to set an error value if the operating parameter reaches the threshold value;
b) Determining an error value when the threshold value is reached;
c) Collecting threshold-value correction data when the threshold is reached or when a situation occurs in which the threshold value is expected to be reached, and transmitting threshold-value correction data to a central data processor;
d) Receiving from a central data processor at least one corrected threshold value for correcting the threshold value during the operation of the safety component, the correction data having been determined from error data that were ascertained in identically designed safety components of other motor vehicles; and
e) Adopting the corrected threshold value as the stored threshold value.

The example method in accordance with the present invention according to the steps a) through e) is carried out in a safety component in a motor vehicle if this safety component operates according to the example method disclosed herein. The method may be used for diagnosing the safety component or in particular for a diagnosis of the correct functioning of the safety component. The operating parameter to be monitored then is not an operating parameter that actually causes the triggering of the safety component once the threshold value is reached, but an operating parameter which is monitored (only) for determining a correct method of operation of the safety component. For example, it is possible that the humidity or the pressure in a safety component is monitored as an operating parameter and a threshold value (humidity threshold value or pressure threshold value) is provided for this purpose. If this threshold value is exceeded or undershot, then this could point to a fault of the safety component which requires servicing or an exchange of the safety component. For instance, one application case of the present method would be the later outcome that a certain pressure or a humidity that was originally considered to be critical and has led to the specification of the initial threshold value, does subsequently turn out to be non-critical after all, so that the threshold value can be corrected and a corrected threshold value then be adopted in step e).

However, the present method may also be used for the actual operation of the safety component. This is so because the operating parameter then is an operating parameter which is used for triggering an airbag, for example, and the fault value then is the trigger signal that triggers the airbag once the threshold value is reached. In this constellation, the present method makes it possible to correct initial threshold values for triggering an airbag, for instance when it turns out that an airbag was triggered too early and a corrected threshold value is therefore adopted in step e), which causes the airbag to be triggered only at a later instant.

A safety component is any safety component of a motor vehicle. Examples of such safety components are, for instance, the already mentioned airbag, brake systems, systems for carrying out emergency driving maneuvers, belt tensioners, etc.

The determination of a stored threshold value in step a) normally includes access to a memory location in a control unit where the stored threshold value is stored. As mentioned, the threshold value serves the purpose of allowing for a comparison with an operating parameter in order to set an error value if the threshold value is reached. Reaching in this context means that the operating parameter exceeds the threshold value or undershoots it, depending on what type of parameter is involved. Some operating parameters should not exceed maximum threshold values. Other operating parameters should not drop below minimum threshold values. Therefore, the threshold value may optionally be a maximum threshold value or a minimum threshold value.

An error value may either be a value which is used to activate a trigger function of the safety component, e.g., to inflate an airbag or something similar. An error value can also be a value that is collected merely for diagnostic purposes, e.g., in order to determine that an airbag functions correctly or that an error exists in or on the airbag, which should be corrected within the framework of a maintenance operation of the system.

The term “error value” in particular describes a binary value (a binary flag), which is set or not set as a function of the comparison of the threshold value and the operating parameter. Thus, the error value as a binary flag may always have two different states, e.g., “triggers airbag”/“does not trigger airbag”, or “an error has occurred”/“no error has occurred”.

An operating parameter is any operating parameter of the safety component. For example, an operating parameter may be a temperature or a signal of a trigger component of the safety component. It is also possible that an operating parameter is a calculated value which in turn was calculated from one or more further operating variable(s).

The ascertaining of the error value is carried out accordingly in step b); in this context, all that was mentioned above for the threshold value in connection with step a) applies to step b) as well.

Step b) defines an alternative for when threshold value correction data are ascertained, i.e., when a situation arises in which it is expected that the threshold value will be reached. There are situations in which the threshold value itself has not yet occurred but where the situations are still relevant for a correction of threshold values because these situations may possibly indicate that threshold values can be set more generously, etc. In order to also cover situations of this type, it is alternatively provided to already collect threshold-value correction data when it is expected that the threshold value will be reached. The situation where the threshold value is expected to be reached does not necessarily mean that the reaching of the threshold value must later actually occur. A situation in which the threshold value is expected to be reached may also develop differently from the expectation, so that the expected reaching of the threshold value actually does not occur at a later point in time. In a simple embodiment variant, a situation in which the threshold value is expected to be reached may be characterized by what is known as a pre-threshold value. A pre-threshold value is a threshold value just barely above or below the actual threshold value (such as 10 percent above or below the actual threshold value). When this pre-threshold value is reached, then a situation exists per definition in which it is likely that the threshold value will be reached. However, such a situation may also be defined by more complex conditions which are checked in order to determine whether such a situation is at hand. For example, one or more (further) operating parameter(s) or operating data of a vehicle may be monitored and compared to threshold values or also to one another in order to identify a situation in which the threshold value is expected to be reached. In this context, operating data and operating parameters in particular include environment data from the environment of the motor vehicle that were ascertained with the aid of an environment sensor system.

The collection of threshold-value correction data in step c) in particular takes place by writing the relevant threshold-value correction data into a memory provided for this purpose (e.g., a data memory in a control unit, typically a RAM/random access memory). Threshold-value correction data, for example, are data relating to the operating parameter before, after or while the threshold value is reached, as well as data with regard to further operating parameters at the time when the threshold value is reached and also prior to and following this occurrence.

The transmitting of threshold-value correction data to a central data processor will be described in greater detail later in the text. The central data processor is preferably implemented so that threshold-value correction data from different safety components (preferably) having the same design, of (preferably) different motor vehicles are merged in order to process them with one another and to ascertain at least one corrected threshold value based on the threshold-value correction data. Processing with one another in this case in particular includes at least one of the following measures:
evaluating different threshold-value correction data,
comparing different threshold-value correction data,
understanding different threshold-value correction data, and
interpreting different threshold-value correction data and especially their meaning.

The receiving of at least one corrected threshold value for correcting the threshold value during the operation takes place in step d) by the central data processor.

In step e), this corrected threshold value is then adopted so that the safety component is operated using the corrected threshold value following step e).

Threshold values may especially also be denoted as BIST limits or as error filter limits because these threshold values are used to detect certain variables (operating parameters) as errors only if the threshold value is reached.

The method in accordance with an example embodiment of the present invention allows for a systematic evaluation of the ascertained threshold-value correction data across the service life of a safety component in the field and for an adaptation of the (BIST) limits and the error-filter limits per flash-over-the-air (FOTA) based on these findings. Threshold-value correction data may particularly also be described as behavioral data because threshold-value correction data describe the behavior of the safety component when the threshold value is reached.

An adaptation of the BIST limits and the error-filter limits during the active service life of ECUs in the field may have the following advantages, among others:
Avoiding unnecessary returns/recalls due to limits that are too narrowly selected,
selective recalling of abnormal ECUs while avoiding a comprehensive recall, and
retroactive tightening of limits given new indications of relevant faulty behavior, and thus an avoidance of potentially safety-relevant failures.

As is current practice, the initial BIST limits and error-filter limits are defined during the development phase of an ECU. This corresponds to step a) of the described method or to an additional prior step of specifying the threshold values in the development phase.

During the service life phase of a control unit (ECU) in the field, the behavior of the ECUs in the field is now monitored only via a systematic field data acquisition (systematic field data exploration (SFDE)). For example, this includes the acquisition of the following threshold-value correction data (e.g., status of the internal error memories, reset behavior, temperature profiles, vibration profiles, . . . ). It is possible that the described method is carried out only during a first field life phase of a safety component such as in the first models of a motor vehicle equipped with the safety component or in the first year during which a novel safety component is used in the field. At a later point, excellent corrected threshold values are then already available by the present method so that the operation of the described method is able to be deactivated.

In accordance with an example embodiment of the present invention, it is particularly preferred if the receiving of at least one corrected threshold value in step d) takes place during servicing of the safety component or the motor vehicle.

Step e) then preferably also takes place during servicing of the safety component or the motor vehicle. For example, servicing of the safety component or the motor vehicle can be a “regular” vehicle servicing operation within the scope of a workshop visit (workshop interval). The threshold-value correction data are preferably automatically downloaded from a control unit of the motor vehicle after a diagnosis device has been connected to the motor vehicle. Preferably, the threshold-value correction data are then transmitted to the central data processor either subsequently or directly during the evaluation of the diagnosis of the motor vehicle with the aid of the diagnostic device. The same also applies to the receiving of at least one corrected threshold value.

In accordance with an example embodiment of the present invention, it is furthermore especially preferred if the transmitting of threshold-value correction data in step c) or the receiving of at least one corrected threshold value in step d) are carried out via a network interface during the regular operation of the motor vehicle.

One such network interface, for example, may be a (permanent) mobile radio link of a motor vehicle. Such a mobile radio link is frequently also provided in motor vehicles in order to transmit live data from an onboard diagnosis to a central data processor.

The threshold-value correction data are not only behavioral data that describe the behavior of the safety component but also field data that are used in the field (during a regular operation of motor vehicles). These field data, for example also together with the data from analyses of field returns, self-reporting by suppliers and other relevant data from other components, are compared.

Based on this evaluation, new limits for BIST and error filtering are specified and uploaded to the ECUs via flash-over-the-air (FOTA) or via workshop testers. In parallel, these new limits are also introduced into the Bosch production.

In accordance with an example embodiment of the present invention, it is especially preferred if method steps a) through e) are continually repeated during the process. In repetitions of the method, already corrected threshold values are also considered to be (new) initial threshold values in step a), as the case may be.

In accordance with an example embodiment of the present invention, it is especially preferred if the following steps are carried out for collecting threshold-value correction data in step c):
c1) Performing the comparison of the threshold value with the operating parameter;
c2) Storing state information that describes a state of the safety component when the error value is set; and
c3) Providing the state information for an ascertainment of corrected threshold values as threshold-value correction data.

The comparison of the threshold value in step c1) corresponds to the comparison that is already suggested in step a). Step c2) corresponds to the storing of a multitude of further operating parameters of the safety component before, after and while the operating parameter reaches the threshold value. Step c3) clarifies once again that all information collected (in steps c1) and c2)) is made available.

The present method is described in greater detail in the below based on the figure. However, the present method is not restricted to the embodiment in the figure.

### BRIEF DESCRIPTION OF THE DRAWINGS

FIG. 1 shows a method in accordance with an example embodiment of the present invention.

### DETAILED DESCRIPTION OF EXAMPLE EMBODIMENTS

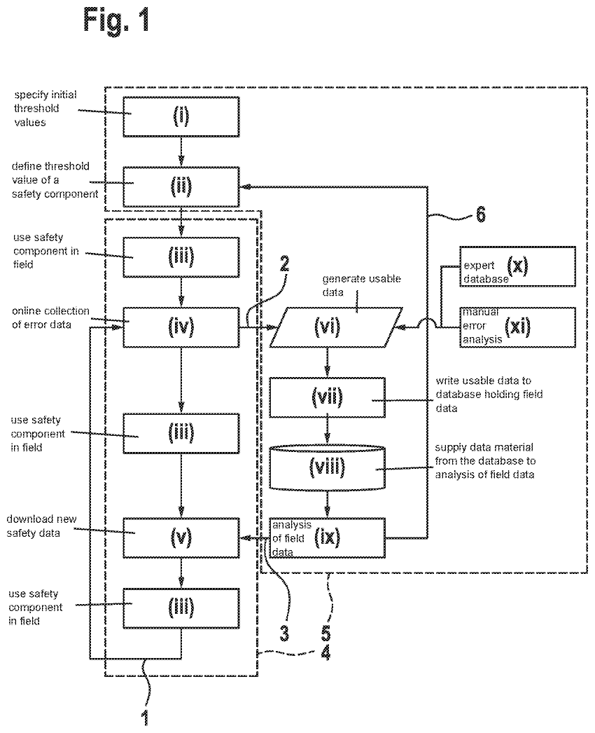

As shown in FIG. 1, the method begins at (i) with the specification of initial threshold values. Based on these initial threshold values, the threshold value for a safety component is defined under (ii). In the process, data from an analysis of field data (ix) are also considered, if appropriate, provided such data are available. In this way the initial threshold values for the safety component may already consider information from field data.

The use of the safety component in the field is then described by (iii). During use of the safety component, an online data collection (iv) of error data takes place while the safety component is in use. The online data collection (iv) is carried out on a regular basis in parallel with the use of the safety component in the field (iii). The online data collection (iv) makes the collected data available to a field-data conditioner (vi), preferably via a network connection 2 depicted here in the form of an arrow.

The same applies to the download of new safety data (v) from the analysis of field data (ix). This download of new safety data (v) also takes place on a regular basis, in parallel with the use of the safety component in the field (iii). The analysis of field data (ix) also makes these new safety data available to the download of new safety data (v) via a network connection 3 likewise depicted here in the form of an arrow.

Here, too, the use of the safety component is shown three times by block (iii) (prior to and following the online data collection (iv) and the download of new safety data (v)). In addition, it is sketched by loop 1 that the use of the safety component in the field (iii) is basically set up on a permanent basis. This constitutes a continual use of the safety component in the field (iii), during which error data are regularly collected by online data collection (iv) and during which new safety data are read in on a regular basis by downloading new safety data (v).

The field-data conditioning (vi) is used to generate usable data from the received field data, which may be used to improve the mentioned threshold values of the safety component. To generate usable data, the field-data conditioner (vi) preferably also uses information from additional data sources such as from an expert database (x) or from a manual error analysis (xi).

Using an update (vii), the usable data are written to the database holding field data (viii). Data material from this database holding field data (viii) is supplied to the analysis of field data (ix) in order to then be able to supply new safety data for the downloading of new safety data (v). The field data (ix) may also be supplied (ii) via link 6 for the purpose of establishing initial threshold values.

The analysis of field data (viii) preferably also supplies data for determining initial threshold values under (ii).

The method steps (iii), (iv) and (v) are preferably carried out in a safety component 4 that may be part of a motor vehicle.

The method steps (i), (ii) as well as (vi), (vii), (viii), (ix), (x) and (xi) are preferably carried out in a central data processor 5 such as on a server of a manufacturer of safety component 4. The safety components are connected to this central data processor 5, preferably permanently or intermittently, via network connections 2 and 3, which are implemented with the aid of mobile radio networks, for instance.

1-7. (canceled)

8. A method for operating a safety component in a motor vehicle, the method comprising the following steps:
a) determining a stored threshold value, which is provided for a comparison with an operating parameter of the safety component, to set an error value when the operating parameter reaches the threshold value;
b) ascertaining an error value when the threshold value is reached;
c) collecting threshold-value correction data when the threshold value is reached or when a situation occurs in which it is expected that the threshold value will be reached, and transmitting threshold-value correction data to a central data processor;
d) receiving from a central data processor at least one corrected threshold value for correcting the threshold value during operation of the safety component, the correction data having been ascertained from error data that were ascertained in identically designed safety components of other motor vehicles; and
e) adopting the corrected threshold as the stored threshold value.

9. The method as recited in claim 8, wherein the transmitting of the threshold-value correction data in step c) or the receiving of at least one corrected threshold value in step d) takes place during servicing of the safety component of the motor vehicle.

10. The method as recited in claim 8, wherein the transmitting of the threshold-value correction data in step c) or the receiving of the at least one corrected threshold value in step d) takes place via a network interface during a regular operation of the motor vehicle.

11. The method as recited in claim 8, wherein steps a) through e) are carried out during regular operation of the safety component.

12. The method as recited in claim 8, wherein the safety component is part of a motor vehicle and serves as passenger protection.

13. The method as recited in claim 8, wherein steps a) through e) are continually repeated during the method.

14. The method as recited in claim 8, wherein the following steps are carried out for collecting threshold-value correction data in the step c):
i. performing the comparison of the threshold value with the operating parameter;
ii. storing state information that describes a state of the safety component when the error value is set;
iii. providing the state information for an ascertainment of corrected threshold values as the threshold-value correction data.
